(19) United States
(12) Patent Application Publication
(10) Pub. No.: US 2022/0124123 A1
(43) Pub. Date: Apr. 21, 2022

(54) SYSTEM, APPARATUS, NODE APPARATUS, GATEWAY APPARATUS, REPEATER APPARATUS, METHOD OF CONTROLLING SYSTEM, PRODUCTION FACILITY, METHOD OF MANUFACTURING PRODUCTS, AND RECORDING MEDIUM

(71) Applicant: CANON KABUSHIKI KAISHA, Tokyo (JP)

(72) Inventor: Kento Watanabe, Kanagawa (JP)

(21) Appl. No.: 17/501,229

(22) Filed: Oct. 14, 2021

(30) Foreign Application Priority Data
Oct. 21, 2020 (JP) 2020-176776

(51) Int. Cl. H04L 29/06; G08C 17/00

(52) U.S. Cl. CPC H04L 65/104; H04L 29/06027; G08C 17/00

(57) ABSTRACT

A system includes a node apparatus, a gateway apparatus, and a computer connected to a network. The node apparatus includes a first apparatus including a master circuit board including a connector, and a first component detachably connected to the connector of the first apparatus. The gateway apparatus includes a second apparatus, and a second component detachably connected to the connector of the second apparatus.

### BACKGROUND OF THE INVENTION

### Field of the Invention

The present invention relates to a system and the like that receive a signal from a sensor installed in a facility such as a machine apparatus, and obtain the state of the facility.

### Description of the Related Art

The operation state of a facility such as a machine apparatus may gradually change, for example, due to the change in state of components of the machine apparatus. When the operation state of the machine apparatus is within an allowable range that is set for the purpose of use of the machine apparatus, the machine apparatus is in its normal state. In contrast, when the operation state of the machine apparatus is out of the allowable range, the machine apparatus is in a failed state. For example, if the machine apparatus is a production machine and operates in the failed state, the production machine will cause trouble such as manufacturing defective products or stopping the production line.

For preventing the failed state as much as possible, maintenance work is commonly performed as preventive safety. For increasing the preventive safety, it is effective that the intervals at which the maintenance work is performed are made shorter. However, if the frequency of maintenance work is excessively increased, the operation rate of the facility will be lowered because the facility is stopped during the maintenance work. As countermeassures, for performing the maintenance work at appropriate timings, a known system receives a signal from a sensor installed in a facility, and obtains the state of the facility.

In general, since a sensor installed in a facility is separated from a computer of a system, it is difficult to send a signal from the sensor directly to the computer. Thus, in a system as described above, a node apparatus and a gateway apparatus are used. The node apparatus receives a signal from the sensor and sends the signal, as data, to the gateway apparatus; and the gateway apparatus receives the data signal from the node apparatus, and uploads the data signal to a network connected with the computer. In addition, a repeater apparatus may be used. The repeater apparatus relays the data signal sent from the node apparatus and sends the data signal to the gateway apparatus, for stabilizing the communication between the node apparatus and the gateway apparatus and increasing the distance in which the node apparatus and the gateway apparatus can communicate with each other.

Japanese Patent Application Publication No. 2018-206030 discloses a node apparatus including a sensor board, a microcomputer board, and a communication board. Each of these boards can be replaced with another board in accordance with the purpose of measurement. Note that in Japanese Patent Application Publication No. 2018-206030, the node apparatus is referred to as a sensor apparatus set. For example, in the node apparatus described in Japanese Patent Application Publication No. 2018-206030, when the type of a sensor used is changed, the sensor board is replaced with another sensor board that is designed for a new sensor. In addition, a plurality of types of communication boards that conforms to different communication standards may be prepared. In this case, one communication board is appropriately replaced with another communication board, so that the node apparatus can perform the communication, while conforming to desired communication standards. Thus, if a plurality of types of boards having different specifications is prepared, and one board is appropriately replaced with another board, the specifications of the node apparatus can be changed.

### SUMMARY OF THE INVENTION

According to a first aspect of the present invention, an apparatus includes a connector. The apparatus is configured to operate as a node apparatus if a first component is connected to the connector, and operate as a gateway apparatus if a second component is connected to the connector.

According to a second aspect of the present invention, a node apparatus includes a master circuit board including a first connector configured to be connected with a network board, and a second connector, and a sensor board detachably connected to the second connector.

According to a third aspect of the present invention, a gateway apparatus includes a master circuit board including a first connector configured to be connected with a sensor board, and a second connector, and a network board detachably connected to the second connector.

According to a fourth aspect of the present invention, a repeater apparatus includes a master circuit board including a first connector configured to be connected with a network board, a second connector configured to be connected with a sensor board, and a third connector, and a repeater board detachably connected to the third connector.

According to a fifth aspect of the present invention, a system includes a node apparatus, a gateway apparatus, and a computer connected to a network. The node apparatus includes a first apparatus including a master circuit board including a connector, and a first component detachably connected to the connector of the first apparatus. The gateway apparatus includes a second apparatus, and a second component detachably connected to the connector of the second apparatus.

Further features of the present invention will become apparent from the following description of exemplary embodiments with reference to the attached drawings.

### BRIEF DESCRIPTION OF THE DRAWINGS

FIG. 1 is a schematic diagram illustrating a system of an embodiment.

FIG. 2A is an external view of a base apparatus of an embodiment.

FIG. 2B is an exploded view of the base apparatus of the embodiment.

FIG. 3A is an external view of a master circuit board of an embodiment.

FIG. 3B is a block diagram of the master circuit board of the embodiment.

FIG. 4 is a diagram illustrating a display portion of an embodiment.

FIG. 5A is a plan view of a master circuit board of an embodiment, viewed from an opening portion side.

FIG. 5B is a plan view of the master circuit board of the embodiment, viewed from a bottom plate side.

FIG. 5C is a plan view of a sensor input board of an embodiment, viewed from the opening portion side.

FIG. 5D is a plan view of the sensor input board of the embodiment, viewed from the bottom plate side.

FIG. 6A is an external view of a node apparatus of an embodiment.

FIG. 6B is an exploded view of the node apparatus of the embodiment.

FIG. 7 is an external view of a master circuit board and a sensor input board of an embodiment.

FIG. 8 is a block diagram of a node apparatus of an embodiment.

FIG. 9A illustrates setting information of an AD converter of a sensor input board of an embodiment.

FIG. 9B is a table illustrating control operations performed by a CPU of a master circuit board of an embodiment.

FIG. 10 is a state transition diagram of a base apparatus of an embodiment.

FIG. 11 is a flowchart for an operation control method of an embodiment.

FIG. 12A is an external view of a gateway apparatus of an embodiment.

FIG. 12B is an exploded view of the gateway apparatus of the embodiment.

FIG. 13 is an external view of a master circuit board and a network board of an embodiment.

FIG. 14 is a block diagram of a gateway apparatus of an embodiment.

FIG. 15 illustrates information on an Ethernet controller of a network board of an embodiment.

FIG. 16A is an external view of a repeater apparatus of an embodiment.

FIG. 16B is an exploded view of the repeater apparatus of the embodiment.

FIG. 17 is an external view of a master circuit board and a repeater board of an embodiment.

FIG. 18 is a block diagram of a repeater apparatus of an embodiment.

FIG. 19A is an external view of a multifunction apparatus of an embodiment.

FIG. 19B is an exploded view of the multifunction apparatus of the embodiment.

FIG. 20 is an external view of a master circuit board, a sensor input board, and a network board of an embodiment.

FIG. 21 is a block diagram of a multifunction apparatus of an embodiment.

FIG. 22 illustrates an example of the screen of a computer of a system of an embodiment.

### DESCRIPTION OF THE EMBODIMENTS

In the above-described system, when the facility whose state is obtained is changed or enlarged, the size of the system or the arrangement of components of the system may need to be changed, accordingly. In addition, even if the facility whose state is obtained is unchanged, the number, type, and arrangement of sensors of the system may need to be changed when the maintenance work is changed, for example. In such a case, the node apparatus, the gateway apparatus, and the repeater apparatus of the system may be changed in number and arrangement.

In the conventional system, however, the node apparatus that performs its node function, the gateway apparatus that performs its gateway function, and the repeater apparatus that performs its repeater function are dedicated apparatuses that perform respective functions.

Thus, if it is required to keep the total number of components of the system constant and to change the percentage of each type of components, the node apparatuses may remain in excess and the gateway apparatuses may run short, for example. Thus, if many dedicated apparatuses of each type are prepared for the change of the system, procurement costs and the storage space will be increased disadvantageously.

Note that the sensor apparatus set described in Japanese Patent Application Publication No. 2018-206030 can increase the versatility of the node apparatus because the type of a sensor or the communication mode can be changed by replacing one board with another board. However, the sensor apparatus set merely increases the versatility of the node apparatus alone. Thus, the above-described problems, caused in the system that also includes apparatuses other than the node apparatus, cannot be solved by the method of Japanese Patent Application Publication No. 2018-206030.

For this reason, it has been desired to achieve a system that can easily change the size and layout of the system without requiring excessive costs and storage space, and to achieve a node apparatus, a gateway apparatus, and a repeater apparatus that constitute the system.

Hereinafter, a system of an embodiment of the present invention, and a base apparatus, a node apparatus, a gateway apparatus, and a repeater apparatus that constitute the system will be described with reference to the accompanying drawings.

Note that in the drawings that will be referred to in the following embodiments, a component given an identical reference numeral has an identical or similar function, unless otherwise specified.

### System

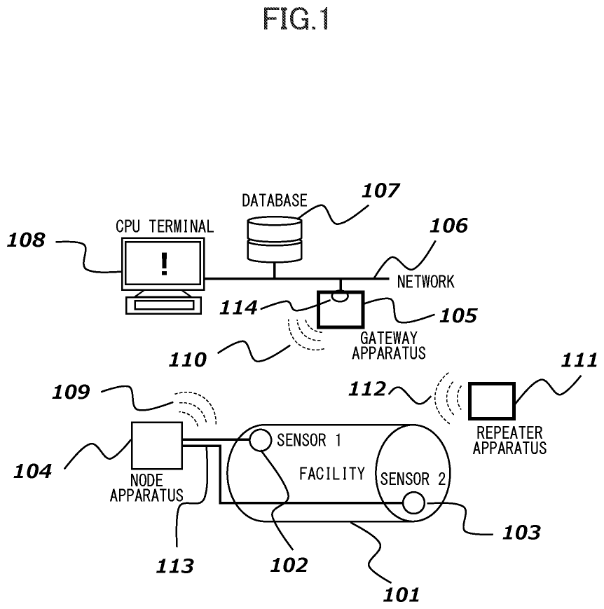

FIG. 1 is a schematic diagram for illustrating a system of an embodiment that obtains the state of a facility and monitors the facility. A production facility 101 that is monitored is not limited to a specific facility as long as the facility is used for manufacturing products. For example, the production facility 101 may be any one of various facilities including a robot apparatus, a coating apparatus, an additive manufacturing apparatus, a cutting apparatus, a mold apparatus, a heating furnace, and a reacting furnace.

Sensors 102 and 103 are disposed for measuring physical quantities related to the state of the production facility 101. The number of the sensors is not limited to two, and may be three or more. Types of the sensors are appropriately selected in accordance with the type of the production facility 101. For example, each sensor used may be a vibration sensor, an acceleration sensor, a pressure sensor, a photosensor, a torque sensor, or a temperature sensor; and can output a measured physical quantity, as an analog or digital signal. Note that the sensors may be disposed in the production facility 101 in advance, or may be additionally attached to the production facility 101, together with the node apparatus 104, for building the system.

The node apparatus 104 is connected with the sensors 102 and 103 via sensor wires 113; and sends measurement results measured by the sensors 102 and 103, to the gateway apparatus 105, as digital measurement data, by using a first communication portion 109. Note that the node apparatus disposed for the production facility may not be a single apparatus, and a plurality of node apparatuses may be disposed in the production facility in accordance with the number of sensors.

The first communication portion 109 of the node apparatus 104 can communicate with a second communication portion 110 of the gateway apparatus 105, and the Low Power Wide Area (LPWA) or the wireless LAN may be used for the communication.

In the system of the embodiment, in a case where the node apparatus 104 is disposed far from the gateway apparatus 105 or installed in an environment that interferes with the radio wave used for the communication, a repeater apparatus 111 is disposed for relaying the communication. The repeater apparatus 111 is disposed between the node apparatus 104 and the gateway apparatus 105, and includes a third communication portion 112. Upon receiving the signal sent from the first communication portion 109, the third communication portion 112 transforms the signal into a radio wave stronger than the received signal, for relaying the communication. Note that the repeater apparatus 111 may not be a single apparatus, and a necessary number of repeater apparatuses may be disposed in accordance with the communication distance or the communication environment.

The gateway apparatus 105 collects measurement data measured by the sensors and sent from the node apparatus 104, and stores the measurement data in a storage portion 107 of the system. Thus, the gateway apparatus 105 includes the second communication portion 110 that causes the gateway apparatus 105 to communicate with the node apparatus 104, and a fourth communication portion 114 (e.g., a network interface such as an I/O port) that causes the gateway apparatus 105 to be connected with a network 106, to which the storage portion 107 is connected.

The network 106 may be a dedicated local area network (LAN) laid in a factory in which the production facility 101 is operated, or may be a wide area network such as the Internet.

The storage portion 107 connected to the network 106 is a storage device, such as an HDD, an SSD, a flexible disk, an optical disk, a magneto-optical disk, or a magnetic tape; and a storage area of the storage portion 107 is used to build a database that stores the measurement data.

In addition, a computer 108 is connected to the network 106. The computer 108 is a control device in which the software to control the operation of the system is implemented.

For example, when the gateway apparatus 105 receives measurement data measured by the sensors and sent from the node apparatus 104, the gateway apparatus 105 sends a data receipt notification to the computer 108 and stores the measurement data in the storage portion 107. Upon receiving the data receipt notification from the gateway apparatus 105, the computer 108 starts a program that analyzes measurement data, and analyzes the state of the production facility 101 by processing the measurement data stored in the storage portion 107. Then the computer 108 notifies the information on the state of the production facility 101 (for example, whether the production facility 101 is in an abnormal state) to an administrator, by sending an electronic mail, causing a display portion to display a message, or issuing an alert, for example. Since the above-described method of notifying an administrator of the information is one example, the operation of the system may be set as appropriate. For example, the computer 108 may perform only the process to read the measurement data from the storage portion 107 and display the measurement data, and an administrator may analyze the state of the production facility 101 by using the measurement data.

Next, the node apparatus 104, the gateway apparatus 105, and the repeater apparatus 111, which are components of the system of the present embodiment, will be more specifically described.

In each of these three apparatuses, a component (for example, a dedicated printed circuit board for the apparatus) on which an electric circuit is mounted is attached to a corresponding base apparatus having substantially identical specifications. The base apparatus having the substantially identical specifications includes a connector, a CPU, and a communication unit. The component on which the electric circuit is mounted is electrically and detachably connected to the base apparatus via the connector of the base apparatus, and the CPU serves as a processing portion. Note that the component on which the electric circuit is mounted is typically a printed circuit board. However, the component may be a component in which the electric circuit is mounted on a base that is not a board and that has any shape.

When only a component on which a dedicated electric circuit for the node apparatus is mounted, hereinafter referred to as a first component, is attached to the connector of the base apparatus, the base apparatus and the first component constitute the node apparatus 104.

In addition, when only a component on which a dedicated electric circuit for the gateway apparatus is mounted, hereinafter referred to as a second component, is attached to the connector of the base apparatus, the base apparatus and the second component constitute the gateway apparatus 105.

In addition, when both the first component and the second component are attached to the connector of the base apparatus, the base apparatus, the first component, and the second component constitute the multifunction apparatus that can operate as the node apparatus 104 or as the gateway apparatus 105. If a sensor is connected to the first component of the multifunction apparatus, the multifunction apparatus operates as the node apparatus 104. If a network is connected with the second component of the multifunction apparatus, the multifunction apparatus operates as the gateway apparatus 105.

In addition, when a component on which a dedicated electric circuit for the repeater apparatus is mounted, hereinafter referred to as a third component, is attached to the connector of the base apparatus, the base apparatus and the third component constitute the repeater apparatus 111.

In the present embodiment, the node apparatus, the gateway apparatus, or the repeater apparatus can be easily produced by only attaching the first component, the second component, or the third component to the base apparatus. Thus, if an administrator or a user of a facility prepares the first component, the second component, the third component, and a plurality of base apparatuses having substantially identical specifications, the administrator or the user can easily build or change a system, and thus can flexibly operate the system. Compared to the conventional system constituted by the dedicated node apparatus, gateway apparatus, and repeater apparatus, the system of the embodiment allows its size and layout to be easily changed, and does not need excessive costs and storage space.

### Base Apparatus

Next, the base apparatus will be described in detail.

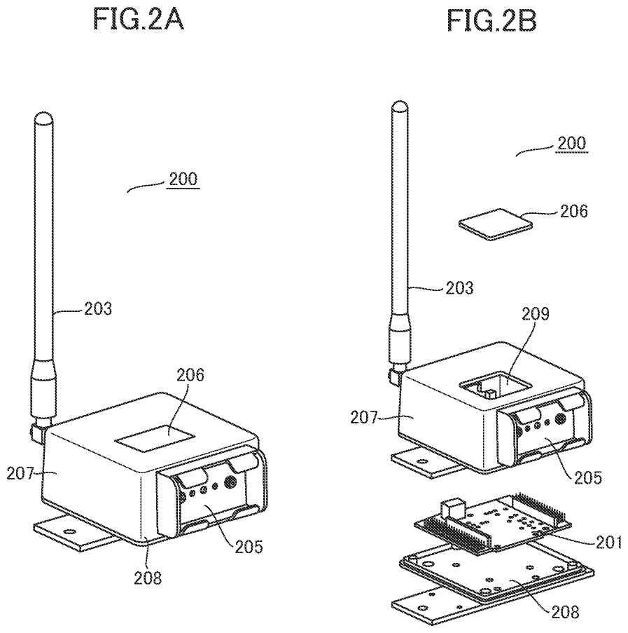

FIG. 2A is an external view of a base apparatus 200, and FIG. 2B is an exploded view for illustrating the internal configuration of the base apparatus 200.

As illustrated in FIG. 2A, the base apparatus 200 includes a bottom plate 208, a cover 207, a lid 206, a communication unit 203, a power supply portion 205, and a master circuit board 201.

The bottom plate 208, the cover 207, and the lid 206 constitute the housing of the base apparatus 200.

The cover 207 is detachably fixed to the bottom plate 208. This is because if the cover 207 is detached from the bottom plate 208, a component (e.g., a printed circuit board) on which an electric component is mounted can be easily placed in the base apparatus 200.

The lid 206 is detachably attached to an opening portion 209 of the cover 207. If the lid 206 is removed, the opening portion 209 can be used as a passage that wires pass through. For example, in a case where the base apparatus constitutes the node apparatus, the lid 206 is removed and the opening portion 209 is used as a passage that sensor wires pass through. On the other hand, the opening portion 209 is not required to be opened, for example, when the base apparatus constitutes the repeater apparatus, or when the base apparatus is kept in a storage space. In this case, the lid 206 is attached to the opening portion 209 for preventing moisture and dust from entering the interior of the base apparatus 200.

The power supply portion 205 serves as a power source of the node apparatus 104, the gateway apparatus 105, the repeater apparatus 111, or a later-described multifunction apparatus 600 produced by using the base apparatus. The power supply portion 205 may include a battery or a rechargeable battery attached to the base apparatus, or may include an AC adapter connected to an external power-supply line. For ensuring the multiplicity of use, the power supply portion 205 may include both the (rechargeable) battery and the AC adapter.

The communication unit 203 may he a wireless communication terminal that operates on the LPWA (low power wide area) or the wireless LAN. In a case where the base apparatus 200 constitutes the node apparatus 104, the communication unit 203 serves as the first communication portion 109 (FIG. 1) of the node apparatus 104. In a case where the base apparatus 200 constitutes the gateway apparatus 105, the communication unit 203 serves as the second communication portion 110 of the gateway apparatus 105. In a case where the base apparatus 200 constitutes the repeater apparatus 111, the communication unit 203 serves as the third communication portion 112 of the repeater apparatus 111.

In addition, as illustrated in FIG. 2B, the base apparatus 200 includes the master circuit board 201 disposed in the housing. The master circuit board 201 is an electric circuit board fixed to the bottom plate 208.

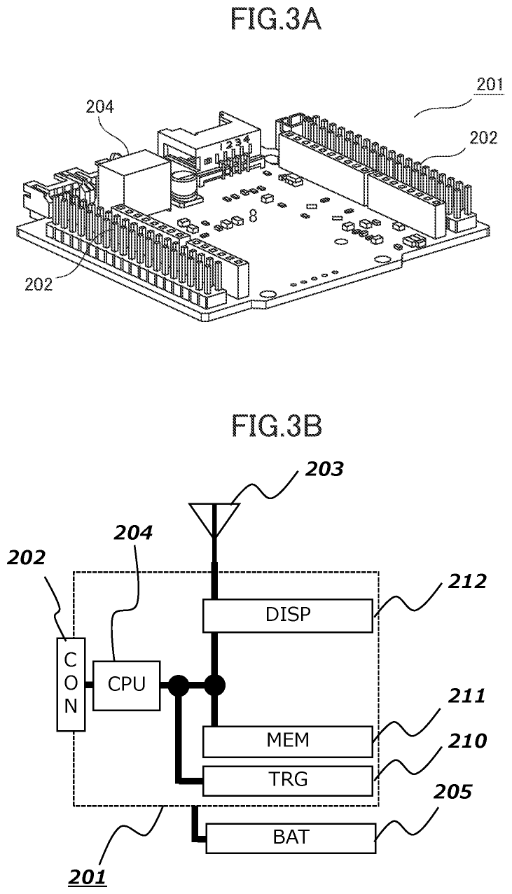

FIG. 3A is an external view illustrating an external appearance of the master circuit board 201, and FIG. 3B is a block diagram for illustrating a configuration of the master circuit board 201.

The master circuit board 201 includes a connector 202, a CPU 204, a trigger portion 210, a memory 211, and a display portion 212; and is connected with the power supply portion 205 and the communication unit 203.

The connector 202 is a connector via which an electric circuit mounted on the first component, the second component, or the third component is detachably connected to the electric circuit of the master circuit board 201.

The CPU 204 is a computer that controls the base apparatus 200. The CPU 204 is programed to determine the type of an electric circuit attached to the connector 202 and control the base apparatus 200 in accordance with the type of the electric circuit attached to the connector 202.

For example, the CPU 204 is programmed so that if only the sensor input board (sensor input circuit), which is the first component, is attached to the connector 202, the base apparatus 200 operates as the node apparatus 104 in cooperation with the sensor input board.

In addition, the CPU 204 is programmed so that if only the network board, which is the second component, is attached to the connector 202, the base apparatus 200 operates as the gateway apparatus 105 in cooperation with the network board.

In addition, the CPU 204 is programmed so that if both the sensor input board and the network board are attached to the connector 202, the base apparatus 200 gives higher priority to one of the sensor input board and the network board and operates in cooperation with the one board. For example, the CPU 204 is programmed so that if a sensor is connected to the sensor input board, the base apparatus 200 operates as the node apparatus 104 in cooperation with the sensor input board. In addition, the CPU 204 is programmed so that if a network is connected with the network board, the base apparatus 200 operates as the gateway apparatus 105 in cooperation with the network board.

In addition, the CPU 204 is programmed so that if only the repeater board, which is the third component, is attached to the connector 202, the base apparatus 200 operates as the repeater apparatus 111.

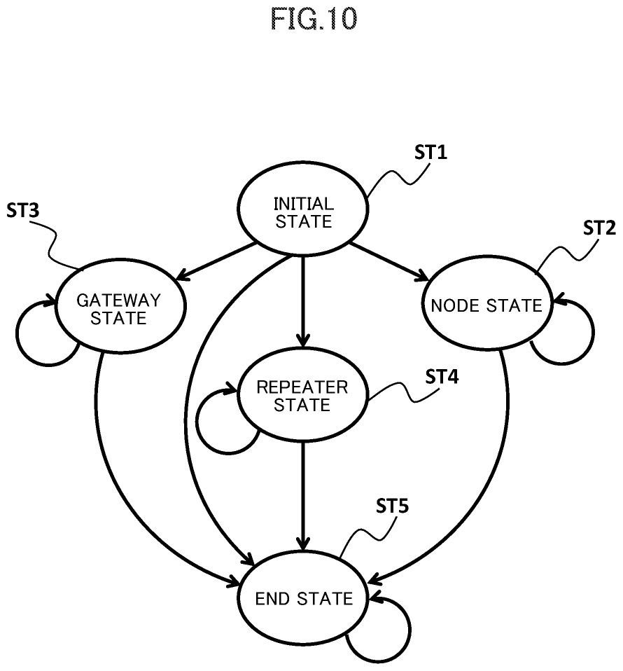

FIG. 10 is a state transition diagram illustrating states that the base apparatus 200 can enter. The base apparatus 200 can enter an initial state (ST1) in which a component is still not attached to the base apparatus 200, a node state (ST2) in which the base apparatus 200 operates as the node apparatus, a gateway state (ST3) in which the base apparatus 200 operates as the gateway apparatus, or a repeater state (ST4) in which the base apparatus 200 operates as the repeater apparatus. In addition, the base apparatus 200 enters an end state (ST5) if a board connected to the master circuit board 201 is removed from the connector after the operation of the base apparatus 200 is completed in any one of the states ST2 to ST4, or if an error of setting information, the trouble of the communication unit 203, or the like is found in the initial state (ST1).

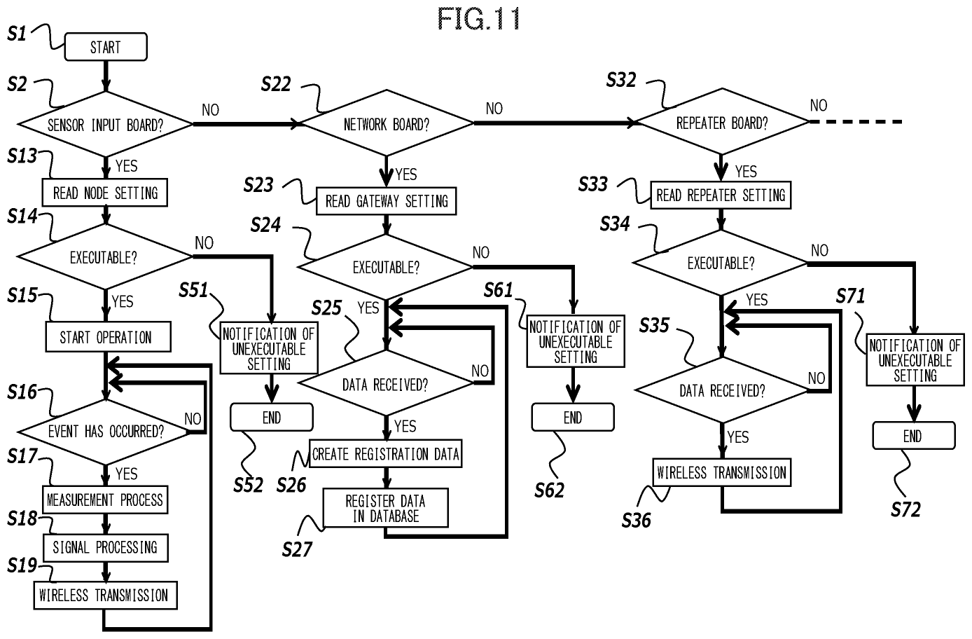

FIG. 11 is a flowchart illustrating a flow of processes performed by the CPU 204. The flowchart will be described in detail later in the description for the node apparatus, the gateway apparatus, and the repeater apparatus.

Referring back to FIG. 3B, the trigger portion 210 of the master circuit board 201 is a function block that generates a trigger event, as a timer does, that causes the start of a predetermined operation. The trigger portion 210 may be a piece of hardware, such as an ASIC, or may be a piece of software that serves as a program that operates the CPU 204.

The memory 211 is a storage device, and includes a ROM (i.e., computer-readable non-transitory recording medium) that stores an operation program of the CPU 204, and a RAM used for data processing and the like.

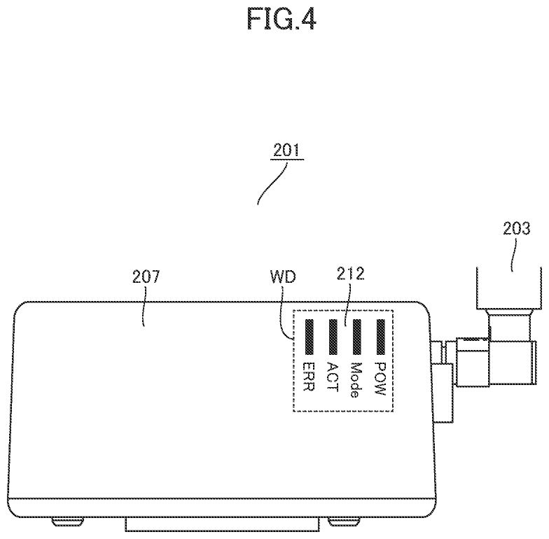

The display portion 212 is a display device that displays the operation state of the apparatus for an operator, and may be an indicator using LED lamps, an LCD device, or an OLED device. The display portion 212 is disposed on the master circuit board 201 at a position at which the display portion 212 can be visually recognized by an operator through the opening portion 209 of the housing. In another case, a window WD may be formed in the cover 207 for an operator to visually recognize the display portion 212, as illustrated in FIG. 4. In this case, the display portion 212 is disposed at a position at which the display portion 212. can be viewed by an operator through the window WD. Note that the display portion 212 may not necessarily be mounted on the master circuit board 201. For example, the display portion 212 may be disposed on an outer surface of the housing of the base apparatus 200, and may be connected to a display signal line extending from the master circuit board 201.

By the way, if the base apparatus 200 constitutes the node apparatus 104, the node apparatus 104 is disposed in the vicinity of the production facility 101, on which the measurement is performed. Thus, the node apparatus 104 may be placed in an environment having high humidity and many sources of contamination such as dust. In addition to this, the lid 206 may be removed to open the opening portion 209 for securing the passage for wires connected to the sensors. For this reason, it is preferable to form a protective film on the master circuit board 201 for preventing the dielectric breakdown and the corrosion of the master circuit board 201 caused by water condensation and adhesion of dust.

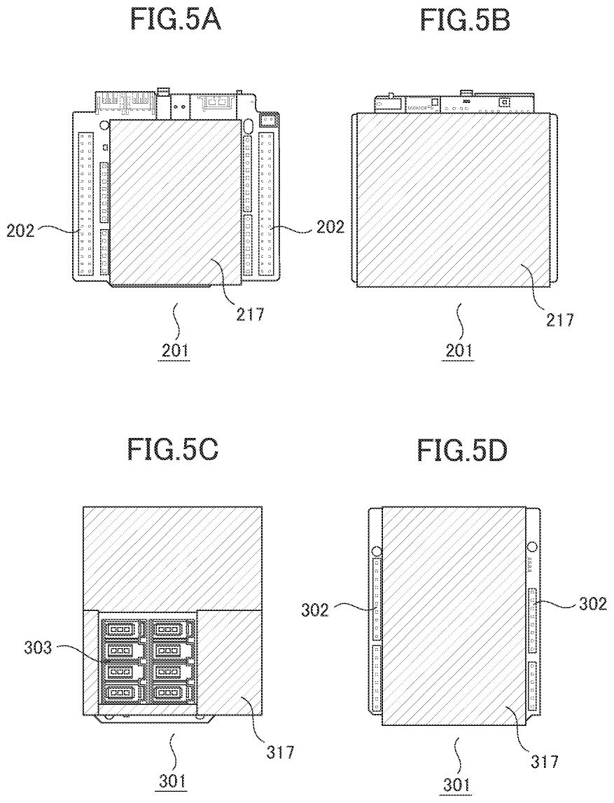

FIG. 5A is a plan view of the master circuit board 201 viewed from the opening portion 209 side. FIG. 5B is a plan view of the master circuit board 201 viewed from the bottom plate 208 side. As illustrated in FIGS. 5A and 5B, the master circuit board 201 is covered with a protective film 217, except for an area in which detachable electric contacts including the connector 202 are disposed. The protective film 217 is different from a resist film of the printed wiring board, and is formed by covering the printed wiring board with a highly moisture-proof and insulating material, such as silicon resin, after components are mounted on the printed wiring board.

Thus, the node apparatus, the gateway apparatus, or the repeater apparatus can be easily produced by only attaching a component on which an electric circuit is mounted, to the connector included in the base apparatus of the above-described embodiment. Thus, if an administrator or a user of a facility prepares a plurality of base apparatuses, the administrator or the user can easily build or change a system, and thus can flexibly operate the system.

For example, if the total number of the node apparatuses, the gateway apparatuses, and the repeater apparatuses, which constitute a system, is kept constant and the percentage of each type of apparatuses is changed in the conventional system that uses dedicated apparatuses, one type of apparatuses may remain in excess and another type of apparatuses may run short. However, if the base apparatus of the present embodiment is used, one type of apparatuses can be easily changed to another type of apparatuses by only replacing a board attached to the connector included in the base apparatus, with another board.

In addition, the base apparatus of the present embodiment includes the detachable lid. Thus, if the base apparatus constitutes the node apparatus or the gateway apparatus and operates, wires can be easily introduced into the base apparatus from the outside by removing the lid. In contrast, if the base apparatus constitutes the repeater apparatus or is kept in a storage space, the interior of the base apparatus can be protected from the contamination, such as moisture and dust, by closing the lid.

In addition, in the base apparatus of the present embodiment, the master circuit board included in the base apparatus is provided with the protective film for preventing the dielectric breakdown and the corrosion of the master circuit board caused by water condensation and adhesion of contamination such as dust. Thus, the base apparatus exhibits high reliability even when the base apparatus is used for the node apparatus or the gateway apparatus.

Next, examples in which the node apparatus 104, the gateway apparatus 105, or the repeater apparatus 111 is produced by connecting a component (for example, a dedicated circuit board in which a dedicated circuit is mounted on a printed board) to the connector 202 of the base apparatus 200 will be specifically described.

### Node Apparatus

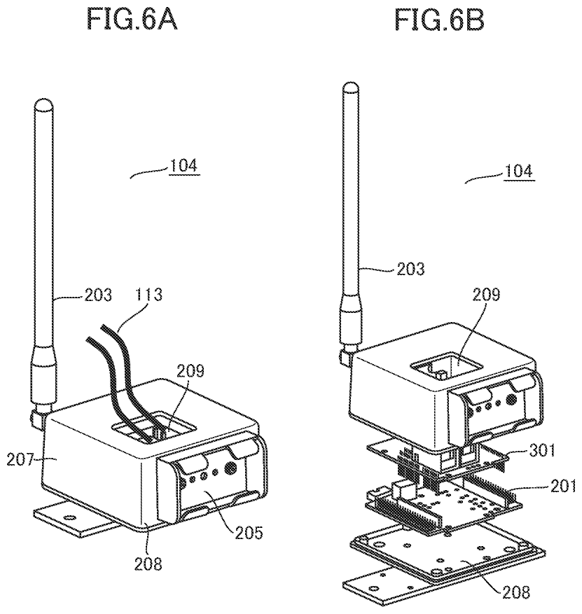

FIG. 6A is an external view of the node apparatus 104 for the system, and FIG. 6B is an exploded view for illustrating the internal configuration of the node apparatus 104. When the sensor input board (first component) on which a dedicated electric circuit for the node apparatus is mounted is attached to the base apparatus, the base apparatus and the sensor input board constitute the node apparatus 104. The node apparatus 104 acquires measurement data from the sensors and sends the measurement data by using the communication unit 203 (i.e., the first communication portion 109 illustrated in FIG. 1).

As illustrated in FIG. 6A, the external appearance of the node apparatus 104 is the same as that of the base apparatus 200 whose opening portion 209 is exposed by removing the lid 206 from the base apparatus 200. In addition, sensor wires 113 are introduced into the housing of the node apparatus 104 through the opening portion 209.

As illustrated in FIG. 6B, a sensor input board 301 is attached to the node apparatus 104, in addition to the components of the base apparatus 200.

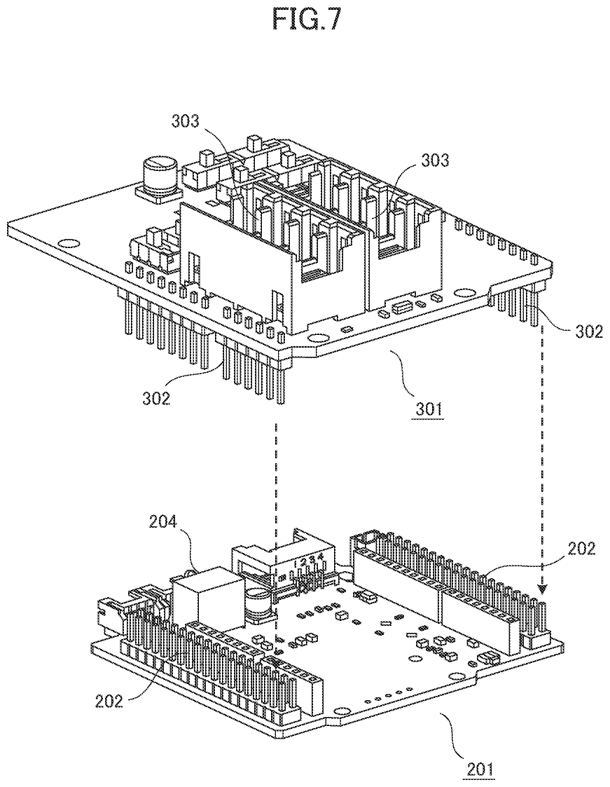

FIG. 7 illustrates an external appearance of the sensor input board 301 and the master circuit board 201. The sensor input board 301 has a connector 302 disposed on a lower surface of the sensor input board 301. The connector 302 can be detachably connected with the connector 202 of the master circuit board 201. When the connector 302 is connected with the connector 202, the electric circuit of the sensor input board 301 is connected with the electric circuit of the master circuit board 201. With this connection, power supply voltages (for example, 5 V and 3.3 V necessary for driving an amplifier, an AD converter, a memory, and the like) are supplied from the master circuit board 201 to the sensor input board 301; and a signal can be sent and received between the sensor input board 301 and the master circuit board 201. Note that a single power supply voltage (e.g., 5 V) may be supplied from the master circuit board 201 to the sensor input board 301. In this case, a transformer (e.g., DUX converter) included in the sensor input board 301 may generate various voltages necessary for driving the above-described components.

Note that the terminals of the connector 202 of the master circuit board 201 are arranged such that some of the terminals of the connector 202 are connected with the connector 302 of the sensor input board 301. The other of the terminals of the connector 202 are disposed at a different position at which the other of the terminals can be connected with a connector of the network board, as described later. That is, terminals of the connector 202 for the sensor input board and terminals of the connector 202 for the network board are disposed at different positions. Consequently, even if the sensor input board and the network board are both connected to the connector 202, mechanical and electrical interference does not occur.

The sensor input board 301 has a connector 303 disposed on an upper surface of the sensor input board 301. The connector 303 is a connector (sensor input terminal) that detachably connects the sensor wires 113, which are connected to the sensors, to the sensor input board 301. After the sensor wires 113 are connected to the sensor input board 301, the sensor input board 301 can supply the sensor driving power to the sensors and receive the measurement signal from the sensors.

In addition, it is preferable to form a protective film on the sensor input board 301 for preventing the dielectric breakdown and the corrosion of the sensor input board 301 caused by water condensation and adhesion of dust. As described previously, this is because the node apparatus 104 is disposed in the vicinity of the production facility 101, on which the measurement is performed, and may be placed in an environment having high timidity and many sources of contamination such as dust.

FIG. 5C is a plan view of the sensor input board 301 viewed from the opening portion 209 side. FIG. 5D is a plan view of the sensor input board 301 viewed from the master circuit board 201 side. As illustrated in FIGS. 5C and 5D, the sensor input board 301 is covered with a protective film 317, except for an area in which detachable electric contacts including the connectors 302 and 303 are disposed. The protective film 317 is different from a resist film of the printed wiring board, and is formed by covering the printed wiring board with a highly moisture-proof and insulating material, such as silicon resin, after components are mounted on the printed wiring board.

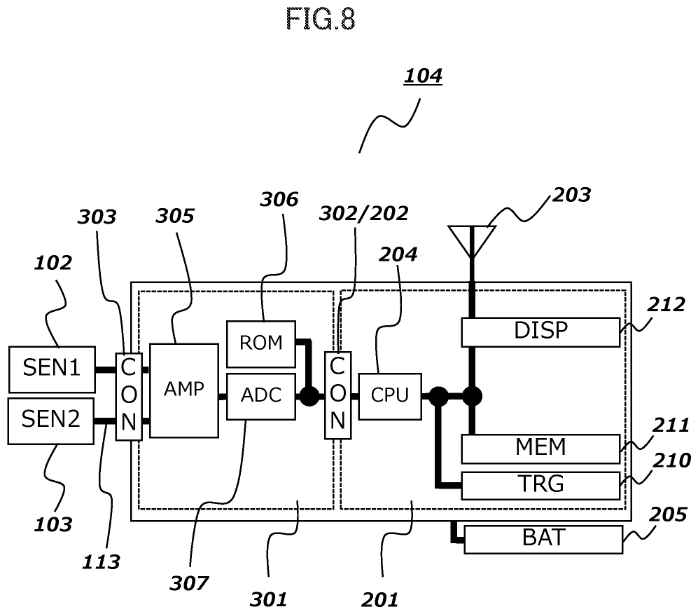

FIG. 8 is a block diagram for illustrating a circuit configuration of the node apparatus 104. In the node apparatus 104, the sensor input board 301 and the master circuit board 201 are connected with each other via the connector 302 of the sensor input board 301 and the connector 202 of the master circuit board 201.

The sensor input board 301 includes an amplifier 305, an AD converter 307, and a ROM 306. The ROM 306 stores identification information that indicates that the sensor input board 301 is a sensor input board. When the CPU 204 of the master circuit board 201 detects that a board has been attached to the connector 202, the CPU 204 reads the identification information from the ROM 306, and thereby recognizes that the board having been attached to the connector 202 is the sensor input board 301.

Then the CPU 204 starts a control program that causes the base apparatus to operate as the node apparatus, and starts the operation control of the node apparatus. The display portion 212 displays information indicating that the base apparatus is operating as the node apparatus.

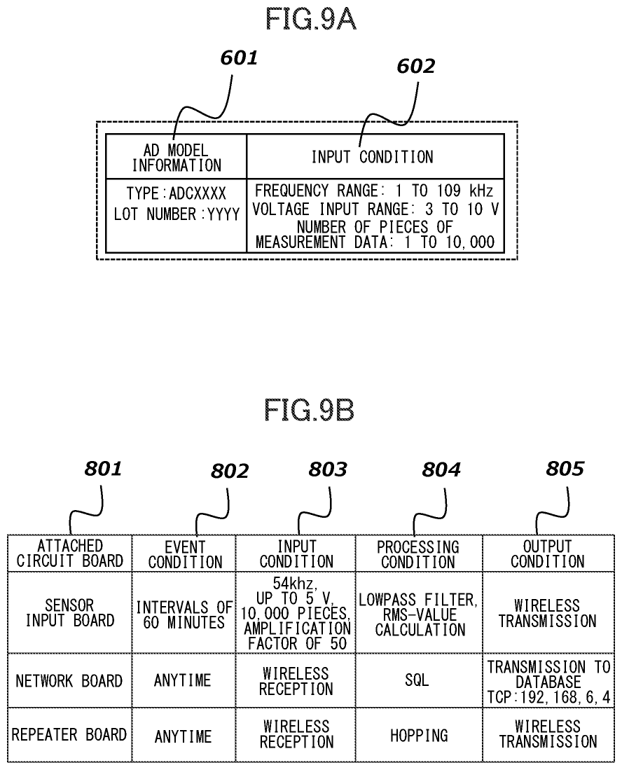

The ROM 306 of the sensor input board 301 also stores information on the setting of operation of the amplifier 305 and the AD converter 307, in addition to the previously-described basic identification information. FIG. 9A illustrates one example of the information on the setting of operation of the AD converter 307. In this example, in a column 601, the type and the lot number of the AD converter 307 are described as the type information of the AD converter 307. In addition, in column 602, a frequency range, an input voltage range, and the number of pieces of measurement data are described as input condition. The CPU 204 of the master circuit board 201 reads the setting information from the ROM 306, and sets or changes the operation of the amplifier 305 and the AD converter 307 in accordance with the type of a sensor connected to the sensor input board 301 and the purpose of measurement.

The amplifier 305 is a circuit that amplifies analog measurement signals sent from the sensors 102 and 103 via the sensor wires 113 and the connector 303. For example, if the sensor 102 is a vibration sensor and the sensor 103 is a pressure sensor, the amplifier 305 amplifies an analog measurement signal at an appropriate amplification factor for each sensor, for causing the analog measurement signal outputted from the sensor to satisfy the input condition of the AD converter 307.

The AD converter 307 converts the amplified analog measurement signal to a digital signal. Specifically, the AD converter 307 performs the AD conversion at a sampling rate and the number of pieces of measurement data, which are suitable for the frequency characteristics of the analog measurement signal and the purpose of measurement.

FIG. 9B is a table illustrating an example of control operation performed by the CPU 204 when one of various dedicated circuit boards is attached to the connector 202 of the master circuit board 201. The contents of the control operation are stored, as a control program, in the memory 211 of the master circuit board 201.

In this case, since the sensor input board 301 is attached to the connector 202, the sensor input board is described in a column 801. In columns 802 to 805 corresponding to the column 801 and formed next to the column 801, the control operations that causes the base apparatus to operate as the node apparatus are described.

For example, in the column 802, an event condition is described. The trigger portion 210 of the master circuit board 201 generates trigger signals at intervals of 60 minutes so that the node apparatus 104 performs measurement and sends data under the event condition. In the column 803, input conditions are described. The node apparatus 104 acquires measurement signals from the sensors, under the input conditions. In the column 804, processing conditions are described. The node apparatus 104 processes the measurement signals, under the processing conditions. In the column 805, an output condition is described. The node apparatus 104 sends the measurement data wirelessly by using the communication unit 203, under the output condition.

Next, with reference to the flowchart of FIG. 11, processes performed by the CPU 204 of the master circuit board 201 will be described. When the power is turned on, the CPU 204 starts to determine whether a circuit board is connected to the connector 202 of the master circuit board 201 (Step S1). If the CPU 204 detects the connection of the circuit board, then the CPU 204 accesses the ROM of the circuit board that has been connected to the connector 202, and reads the information on the type of the circuit board. Then the CPU 204 executes Step S2, S22, S32, . . . for determining the type of the circuit board.

If the CPU 204 determines that the board connected to the connector 202 is a sensor input board (Step S2: YES), then the CPU 204 proceeds to Step S13. In Step S13, the CPU 204 accesses the memory 211 of the master circuit board 201 and the ROM 306 of the sensor input board 301, and obtains setting information from each of the memory 211 and the ROM 306. In Step S14, the CPU 204 compares the setting of operation of the node apparatus stored in the memory 211 and the basic setting of the sensor input board stored in the ROM 306, and checks whether the CPU 204 can execute the setting of operation of the node apparatus by using the sensor input board connected to the connector 202.

If the CPU 204 determines that the CPU 204 cannot execute the operation that is set in the memory 211, by using the sensor input board connected to the connector 202 (Step S14: NO), then the CPU 204 proceeds to Step S51, and notifies an operator that the setting of operation of the node apparatus cannot be executed, by using the display portion 212 or the communication unit 203 for example. If the communication unit 203 is used, the CPU 204 sends the notification to a computer 108 that controls the whole operation of the system, via the gateway apparatus 105 illustrated in FIG. 1. Then the CPU 204 proceeds to Step S52, and ends the process.

If the CPU 204 determines that the CPU 204 can execute the operation that is set in the memory 211, by using the sensor input board connected to the connector 202 (Step S14: YES), then the CPU 204 proceeds to Step S15, and starts to execute the operation program described with reference to FIG. 9B. Specifically, the CPU 204 proceeds to Step S16, and determines whether an event has occurred under the event condition.

If the CPU 204 has not received from the trigger portion 210 a notification (e.g., interrupt notification) indicating that an event has occurred under the event condition (Step S16: NO), then the CPU 204 repeats Step S16 and waits for the occurrence of an event.

If the CPU 204 has received from the trigger portion 210 a notification (e.g., interrupt notification) indicating that an event has occurred under the event condition (Step S16: YES), then the CPU 204 proceeds to Step S17 and acquires measurement data under the input conditions described in the column 803 of FIG. 9B. That is, the CPU 204 causes the amplifier 305 to amplify the measurement signal outputted from the sensor, then causes the AD converter 307 to digitize the amplified measurement signal, and stores the digitized measurement signal in a RAM of the memory 211.

Then the CPU 204 proceeds to Step S18; performs data processing on the digitized measurement data, under the processing conditions described in the column 804 of FIG. 9B; and creates send data. The send data may be temporarily stored in the RAM of the memory 211.

Then the CPU 204 proceeds to Step S19; and transmits the send data wirelessly by using the communication unit 203, under the output condition described in the column 805 of FIG. 9B. After the CPU 204 has completed the series of processes, from the process to receive the measurement signal from the sensor to the process to transmit the send data wirelessly, the CPU 204 returns to Step SI 6 and waits for the occurrence of the next trigger event.

The node apparatus of the embodiment has been described above. Since the node apparatus described above is merely one example, the configuration of the node apparatus and the method of controlling the node apparatus can be changed as appropriate. For example, in a case where the sensor connected to the node apparatus outputs not an analog signal but a digital signal, the sensor input board may include a buffer for the digital signal, in place of the amplifier and the AD converter.

The node apparatus of the present embodiment can be easily produced by only attaching the sensor input board to the base apparatus. Thus, if an administrator or a user of the system prepares a plurality of base apparatuses and a plurality of sensor input boards, the administrator or the user can easily change the number of node apparatuses installed in the system. In addition, the node apparatus of the present embodiment becomes the base apparatus again if the sensor input board is removed from the node apparatus. Thus, the node apparatus can be easily changed to the gateway apparatus or the repeater apparatus. In addition, when the node apparatus is kept in a storage space, the interior of the node apparatus can be protected from moisture and dust, by closing the lid.

### Gateway Apparatus

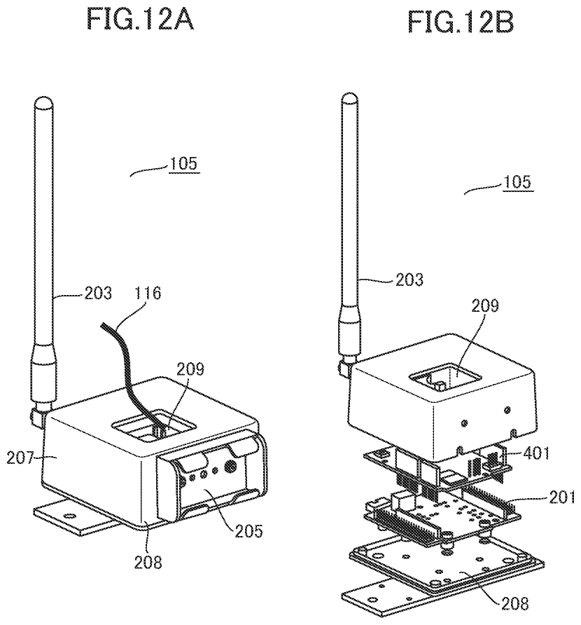

FIG. 12A is an external view of the gateway apparatus 105 for the system, and FIG. 12B is an exploded view for illustrating the internal configuration of the gateway apparatus 105. When the network board (second component) on which a dedicated electric circuit for the gateway apparatus is mounted is attached to the base apparatus, the base apparatus and the network board constitute the gateway apparatus 105.

The gateway apparatus 105 performs wireless communication with the node apparatus by using the communication unit 203 second communication portion 110 illustrated in FIG. 1), also when the communication is relayed by the repeater apparatus: and receives the measurement data from the node apparatus. In addition, the gateway apparatus 105 accesses the network 106 by using the network interface (i.e., the fourth communication portion 114 illustrated in FIG. 1); and stores the measurement data sent from the node apparatus, in the storage portion 107 of the system.

As illustrated in FIG. 12A, the external appearance of the gateway apparatus 105 is the same as that of the base apparatus 200 whose opening portion 209 is exposed by removing the lid 206 from the base apparatus 200. In addition, a network connection line 116 (e.g., a LAN cable) connected with the network 106 is introduced into the interior of the housing of the gateway apparatus 105 through the opening portion 209.

As illustrated in FIG. 12B, a network board 401 is attached to the gateway apparatus 105, in addition to the components of the base apparatus 200.

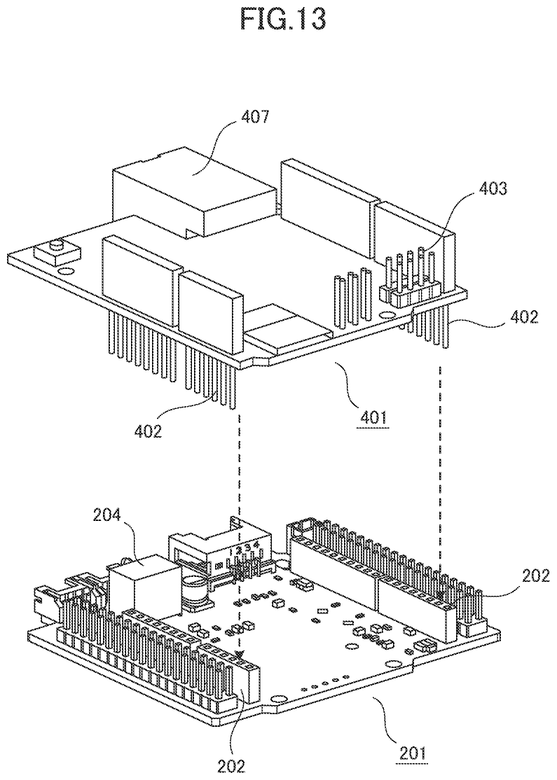

FIG. 13 illustrates an external appearance of the network board 401 and the master circuit board 201. The network board 401 has a connector 402 disposed on a lower surface of the network board 401. The connector 402 can be detachably connected with the connector 202 of the master circuit board 201. When the connector 402 is connected with the connector 202, the electric circuit of the network board 401 is connected with the electric circuit of the master circuit board 201. With this connection, a power supply voltage is supplied from the master circuit board 201 to the network board 401; and a signal can be sent and received between the master circuit board 201 and the network board 401. Note that the network board 401 may be supplied with electric power from the network, via the power over Ethernet (PoE) for example.

Note that the terminals of the connector 202 of the master circuit board 201 are arranged such that some of the terminals of the connector 202 are connected with the connector 402 of the network board 401. The other of the terminals of the connector 202 are disposed at a different position at which the other of the terminals can be connected with the connector of the sensor input board, as described previously. That is, terminals of the connector 202 for the sensor input board and terminals of the connector 202 for the network board are disposed at different positions. Consequently, even if the sensor input board and the network board are both connected to the connector 202, mechanical and electrical interference does not occur.

The network board 401 has an I/O port 403 disposed on an upper surface of the network board 401. The I/O port 403 is a connector (i.e., a network connection terminal) that detachably connects the network connection line 116 (e.g., a LAN cable) connected with the network 106, to the network board 401. After the network connection line 116 is connected to the network board 401, the gateway apparatus 105 can access the network 106 via the network board 401 and store the data in the storage portion 107. Note that there also is a case, as described later, in which the sensor input board 301 is placed over the network board 401, and in which the sensor input board 301 and the network board 401 are mounted on the master circuit board 201. Also in this case, the I/O port 403 is disposed in an edge portion of the network board 401 so that the network connection line 116 can be connected to the network board 401 without interfering with the sensor input board 301.

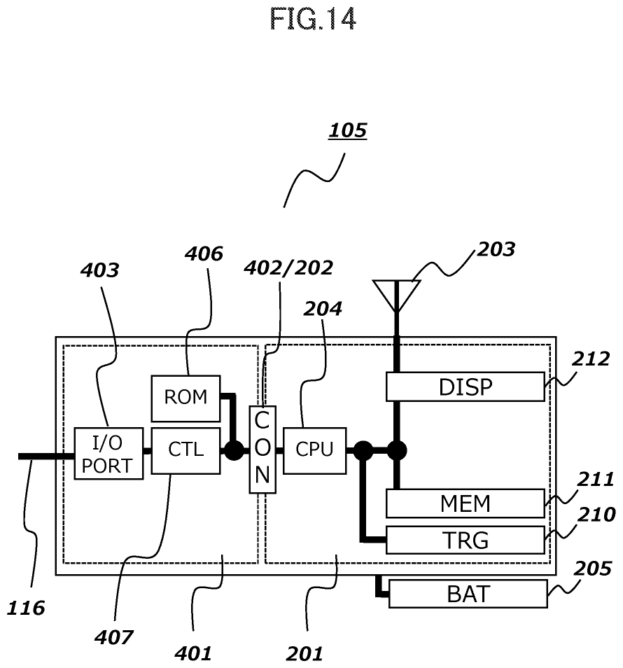

FIG. 14 is a block diagram for illustrating a circuit configuration of the gateway apparatus 105. In the gateway apparatus 105, the network board 401 and the master circuit board 201 are connected with each other via the connector 402 of the network board 401 and the connector 202 of the master circuit board 201.

The network board 401 includes the I/O port 403, an Ethernet controller 407, and a ROM 406. The Ethernet controller 407 is an integrated circuit that controls the Ethernet communication, and allows the gateway apparatus 105 to access the network 106.

The ROM 406 stores identification information that indicates that the network board 401 is a network board. When the CPU 204 of the master circuit board 201 detects that a board has been attached to the connector 202, the CPU 204 reads the identification information from the ROM 406, and thereby recognizes that the board having been attached to the connector 202 is the network board 401.

Then the CPU 204 starts a control program that causes the base apparatus to operate as the gateway apparatus, and starts the operation control of the gateway apparatus.

The display portion 212 displays information indicating that the base apparatus is operating as the gateway apparatus.

The ROM 406 of the network board 401 stores, in addition to the above-described board identification information, information on the type of the Ethernet controller 407 and information on variable setting items and ranges of the setting items. Note that the ROM 406 may be incorporated in the Ethernet controller 407.

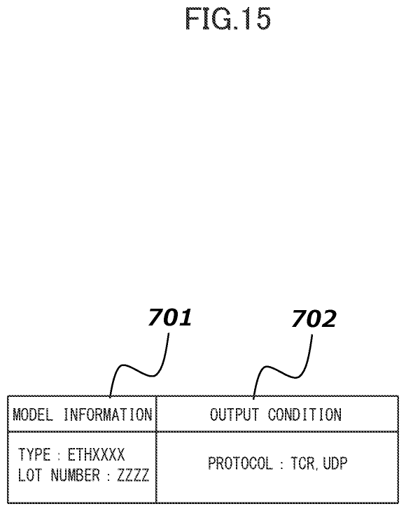

FIG. 15 illustrates one example of the information on the Ethernet controller 407, written in the ROM 406. In this example, in a column 701, the type and the lot number of the Ethernet controller are described as the type information of the Ethernet controller. In addition, in column 702, a communication protocol is described as output condition. The CPU 204 of the master circuit board 201 reads the information from the ROM 406, and sets or changes the operation of the Ethernet controller 407.

Next, with reference to FIG. 9B, a control operation performed by the CPU 204 of the master circuit board 201 will be described. The contents of the control operation are stored, as a control program, in the memory 211.

In this case, since the network board 401 is attached to the connector 202, the network board is described in the column 801. In the columns 802 to 805 corresponding to the column 801 and formed next to the column 801, the control operations that cause the base apparatus to operate as the gateway apparatus are described.

For example, in the column 802, an event condition is described. The gateway apparatus 105 is controlled so as to be operated anytime, under the event condition. In the column 803, an input condition is described. The gateway apparatus 105 acquires measurement data via the second communication portion 110 (i.e., the communication unit 203), under the input condition. In the column 804, a processing condition is described. The gateway apparatus 105 creates an SQL statement for registering the acquired measurement data in the database, under the processing condition. In the column 805, an output condition is described. The gateway apparatus 105 stores the measurement data in the storage portion 107 located on the network 106, by using the Ethernet controller 407, under the output condition.

Next, with reference to the flowchart of FIG. 11, processes performed by the CPU 204 of the master circuit board 201 will be described. When the power is turned on, the CPU 204 starts to determine whether a circuit board is connected to the connector 202 of the master circuit board 201 (Step S1). If the CPU 204 detects the connection of the circuit board, then the CPU 204 accesses the ROM of the circuit board that has been connected to the connector 202, and reads the information on the type of the circuit board. Then the CPU 204 executes Step S2, S22, S32, . . . for determining the type of the circuit board.

If the CPU 204 determines that the board connected to the connector 202 is not a sensor input board (Step S2: NO) but a network board (Step S22: YES), then the CPU 204 proceeds to Step S23, and reads the setting information that causes the base apparatus to operate as the gateway apparatus. That is, the CPU 204 accesses the memory 211 of the master circuit board 201 and the ROM 406 of the network board 401, and obtains setting information from each of the memory 211 and the ROM 406 (Step S23). Then the CPU 204 compares the setting of operation of the gateway apparatus stored in the memory 211 and the basic setting of the network board stored in the ROM 406, and checks whether the CPU 204 can execute the operation of the gateway apparatus by using the network board connected to the connector 202 (Step S24).

If the CPU 204 determines that the CPU 204 cannot execute the operation that is set in the memory 211, by using the network board connected to the connector 202 (Step S24: NO), then the CPU 204 proceeds to Step S61, and notifies an operator that the operation of the gateway apparatus cannot be executed, by using the display portion 212 for example. If the Ethernet controller 407 and the I/O port 403 can operate, the CPU 204 may send a message indicating that the operation of the gateway apparatus cannot be executed, to the computer 108 that controls the whole operation of the system, via the network 106. Then the CPU 204 proceeds to Step S62, and ends the process.

If the CPU 204 determines that the CPU 204 can execute the operation that is set in the memory 211, by using the network board connected to the connector 202 (Step S24: YES), then the CPU 204 loads the control program, the operation of which has been described with reference to FIG. 9B, from the memory 211 and executes the control operation. Then the CPU 204 proceeds to Step S25, and continuously determines whether the communication unit 203 has received measurement data sent from the node apparatus.

If the communication unit 203 has not received measurement data sent from the node apparatus (Step S25: NO), then the CPU 204 repeats Step S25 until the communication unit 203 receives the measurement data.

If the communication unit 203 has received the measurement data (Step S25: YES), then the CPU 204 temporarily stores the measurement data in a RAM of the memory 211, and proceeds to Step S26 and creates an SQL statement for registering the measurement data in the database of the storage portion 107. in Step S27, the CPU 204 executes the SQL statement, and registers the measurement data in the database of the storage portion 107 by operating the Ethernet controller 407 and the I/O port 403.

After the CPU 204 has completed the series of processes, from the process to receive the measurement data to the process to register the measurement data, the CPU 204 returns to Step S25 and waits for the reception of the next measurement data.

The gateway apparatus of the embodiment has been described above. Since the gateway apparatus described above is merely one example, the configuration of the gateway apparatus and the method of controlling the gateway apparatus can be changed as appropriate.

The gateway apparatus of the present embodiment can be easily produced by only attaching the network board to the base apparatus. Thus, if an administrator or a user of the system prepares a plurality of base apparatuses and a plurality of network boards, the administrator or the user can easily change the number of gateway apparatuses installed in the system. In addition, the gateway apparatus of the present embodiment becomes the base apparatus again if the network board is removed from the gateway apparatus. Thus, the gateway apparatus can be easily changed to the node apparatus or the repeater apparatus. In addition, when the gateway apparatus is kept in a storage space, the interior of the gateway apparatus can be protected from moisture and dust, by closing the lid.

### Repeater Apparatus

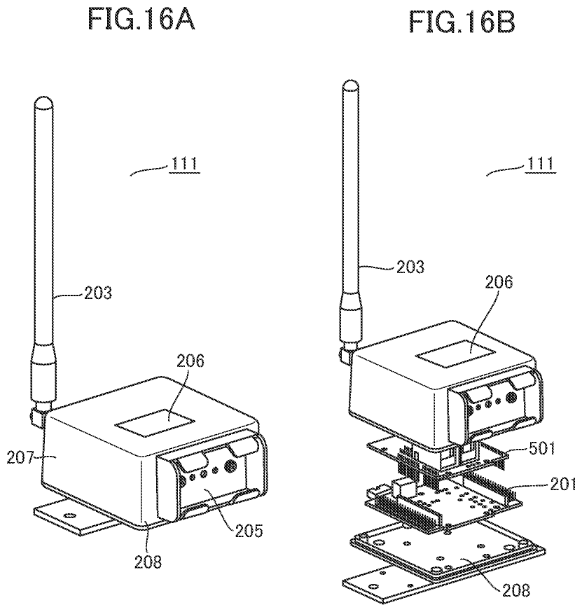

FIG. 16A is an external view of the repeater apparatus 111 for the system, and FIG. 16B is an exploded view for illustrating the internal configuration of the repeater apparatus When the repeater board on which a dedicated electric circuit for the repeater apparatus is mounted is attached to the base apparatus, the base apparatus and the repeater board constitute the repeater apparatus 111.

The repeater apparatus 111 relays the wireless communication between the node apparatus and the gateway apparatus, by using a communication unit 203 (i.e., the third communication portion 112 illustrated in FIG. 1).

As illustrated in FIG. 16A, the external appearance of the repeater apparatus 111 is the same as that of the base apparatus 200 to which the lid 206 is attached. As illustrated in FIG. 16B, a repeater board 501 is attached to the repeater apparatus 111, in addition to the components of the base apparatus 200.

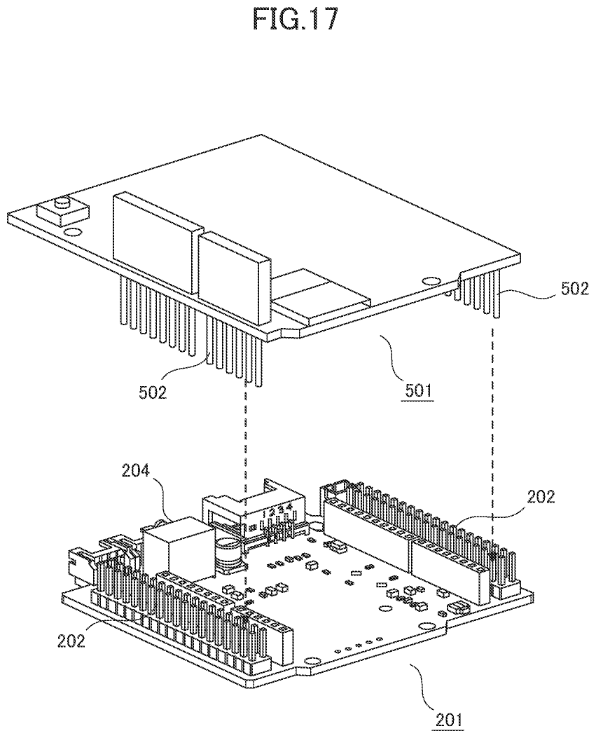

FIG. 17 illustrates an external appearance of the repeater board 501 and the master circuit board 201.

The repeater board 501 has a connector 502 disposed on a lower surface of the repeater board 501. The connector 502 can be detachably connected with the connector 202 of the master circuit board 201. When the connector 502 is connected with the connector 202, the electric circuit of the repeater board 501 is connected with the electric circuit of the master circuit board 201. With this connection, a power supply voltage is supplied from the master circuit board 201 to the repeater board 501; and a signal can be sent and received between the master circuit board 201 and the repeater board 501.

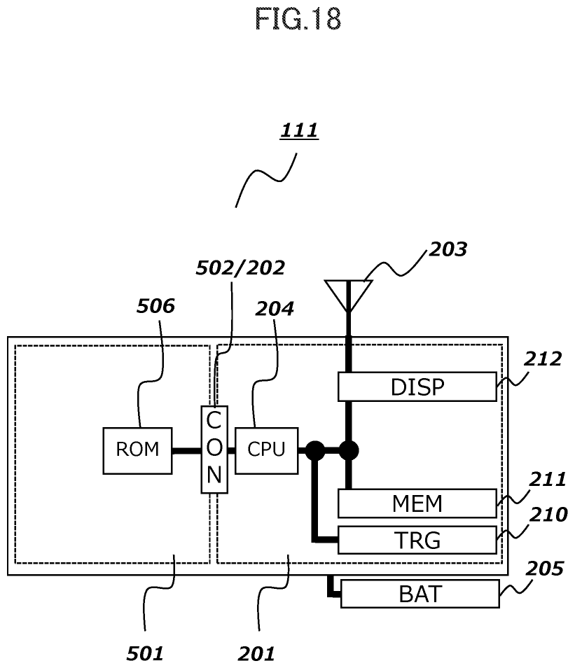

FIG. 18 is a block diagram for illustrating a circuit configuration of the repeater apparatus 111. In the repeater apparatus 111, the repeater board 501 and the master circuit board 201 are connected with each other via the connector 502 of the repeater board 501 and the connector 202 of the master circuit board 201.

The repeater board 501 includes a ROM 506. The ROM 506 stores identification information that indicates that the repeater board 501 is a repeater board. When the CPU 204 of the master circuit board 201 detects that a board has been attached to the connector 202, the CPU 204 reads the identification information from the ROM 506, and thereby recognizes that the board having been attached to the connector 202 is the repeater board 501.

Then the CPU 204 starts a control program that causes the base apparatus to operate as the repeater apparatus, and starts the operation control of the repeater apparatus. The display portion 212 displays information indicating that the base apparatus is operating as the repeater apparatus.

The ROM 506 of the repeater board 501 may store, in addition to the basic identification information, information on setting items that causes the base apparatus to operate as the repeater apparatus. The setting items may include conditions for transmission and reception related to the relay.

Next, with reference to FIG. 9B, a control operation performed by the CPU 204 of the master circuit board 201 will be described as an example. The contents of the control operation are stored, as a control program, in the memory 211.

In this case, since the repeater board 501 is attached to the connector 202, the repeater board is described in the column 801. In the columns 802 to 805 corresponding to the column 801 and formed next to the column 801, the control operations of the repeater apparatus are described.

For example, in the column 802, an event condition is described. The repeater apparatus 111 is controlled so as to be operated anytime, under the event condition. In the column 803, an input condition is described. The repeater apparatus 111 acquires measurement data sent from the node apparatus, by using the third communication portion 112 (i.e., the communication unit 203), under the input condition. In the column 804, a processing condition is described. The repeater apparatus 111 performs a hopping operation, under the processing condition. In the column 805, an output condition is described. The repeater apparatus 111 transmits the acquired measurement data by using the third communication portion 112 (i.e., the communication unit 203), under the output condition.

Next, with reference to the flowchart of FIG. 11, processes performed by the CPU 204 of the master circuit board 201 will be described. When the power is turned on, the CPU 204 starts to determine whether a circuit board is connected to the connector 202 of the master circuit board 201 (Step S1). If the CPU 204 detects the connection of the circuit board, then the CPU 204 accesses the ROM of the circuit board that has been connected to the connector 202, and reads the information on the type of the circuit board. Then the CPU 204 executes Step S2, S22, S32, . . . for determining the type of the circuit board.

If the CPU 204 determines that the board connected to the connector 202 is neither a sensor input board nor a network board (Step S2: NO, Step S22: NO) but a repeater board (Step S32: YES), then the CPU 204 proceeds to Step S33. In Step S33, the CPU 204 reads the setting information that causes the base apparatus to operate as the repeater apparatus. That is, the CPU 204 accesses the memory 211 of the master circuit board 201 and the ROM 506 of the repeater board 501, and obtains setting information from each of the memory 211 and the ROM 506. In Step S34, the CPU 204 compares the setting of operation of the repeater apparatus stored in the memory 211 and the selling stored in the ROM 506, and checks whether the CPU 204 can execute the operation that is set in the ROM 506.

If the CPU 204 determines that the CPU 204 cannot execute the operation that is set in the memory 211 (Step S34: NO), then the CPU 204 proceeds to Step S71, and notifies an operator that the operation that is set in the memory 211 cannot be executed, by using the display portion 212 or the communication unit 203 for example. If the communication unit 203 is used, the CPU 204 sends the notification to a computer 108 that controls the whole operation of the system, via the gateway apparatus 105 illustrated in FIG. 1. Then the CPU 204 proceeds to Step S72, and ends the process.

If the CPU 204 determines that the CPU 204 can execute the operation that is set in the memory 211 (Step S34: YES), then the CPU 204 loads the control program, the operation of which has been described with reference to FIG. 9B, from the memory 211 and executes the control program. Then the CPU 204 proceeds to Step S35, and continuously determines whether the communication unit 203 has received measurement data sent from the node apparatus.

If the communication unit 203 has not received measurement data sent from the node apparatus (Step S35: NO), then the CPU 204 repeats Step S35 until the communication unit 203 receives the measurement data.

If the communication unit 203 has received the measurement data (Step S35: YES), then the CPU 204 temporarily stores the measurement data in a RAM of the memory 211, and proceeds to Step S36 and sends the stored measurement data wirelessly by using the communication unit 203.

After the CPU 204 has completed the series of processes, from the process to receive the measurement data to the process to send the measurement data wirelessly, the CPU 204 returns to Step S35 and waits for the reception of the next measurement data.

The repeater apparatus of the embodiment has been described above. Since the repeater apparatus described above is merely one example, the configuration of the repeater apparatus and the method of controlling the repeater apparatus can be changed as appropriate.

The repeater apparatus of the present embodiment can be easily produced by only attaching the repeater board to the base apparatus. Thus, if an administrator or a user of the system prepares a plurality of base apparatuses and a plurality of repeater boards, the administrator or the user can easily change the number of repeater apparatuses installed in the system. In addition, the repeater apparatus of the present embodiment becomes the base apparatus again if the repeater board is removed from the repeater apparatus. Thus, the repeater apparatus can be easily changed to the gateway apparatus or the node apparatus. In addition, when the repeater apparatus is kept in a storage space, the interior of the repeater apparatus can be protected from moisture and dust, by closing the lid.

### Multifunction Apparatus

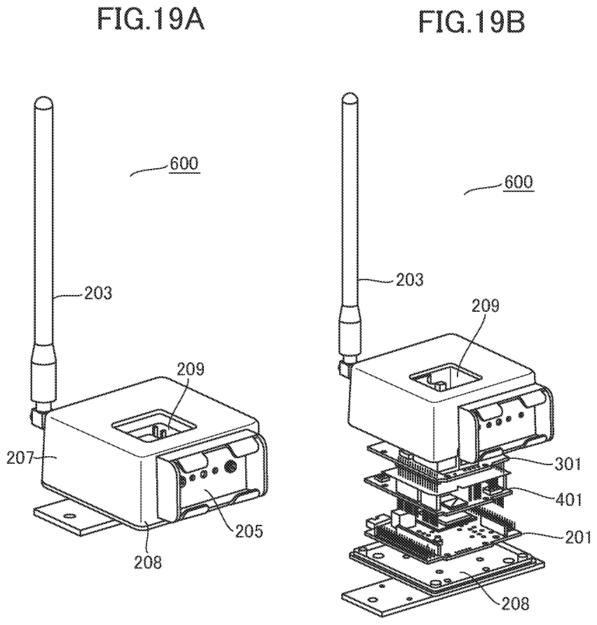

FIG. 19A is an external view of the multifunction apparatus 600 for the system. The multifunction apparatus 600 can serve as the node apparatus or as the gateway apparatus. FIG. 19B is an exploded view for illustrating the internal configuration of the multifunction apparatus 600. When both the sensor input board and the network board are attached to the base apparatus, the sensor input board, the network board, and the base apparatus constitute the multifunction apparatus 600.

The multifunction apparatus 600 functions as the node apparatus when the sensor wires are connected to the sensor input board included in the multifunction apparatus 600, and functions as the gateway apparatus when the network connection line is connected to the network board included in the multifunction apparatus 600. If both the sensor wires and the network connection line are respectively connected to the sensor input board and the network board, the multifunction apparatus 600 functions as the node apparatus or the gateway apparatus on a first-come first-served basis. However, if both the sensor wires and the network connection line are respectively connected to the sensor input board and the network board, the connection between the network and the multifunction apparatus 600 may be given a higher priority and the multifunction apparatus 600 may function as the gateway apparatus. In another case, if both the sensor wires and the network connection line are respectively connected to the sensor input board and the network board, the multifunction apparatus 600 may be controlled such that the multifunction apparatus 600 notifies an operator of an error and waits. Thus, any control method may be set. That is, the control method may be set for convenience of an administrator or a user, and may be registered in advance in the control program of the base apparatus.

As illustrated in FIG. 19A, the external appearance of the multifunction apparatus 600 is the same as that of the base apparatus 200 whose opening portion 209 is exposed by removing the lid 206 from the base apparatus 200. In addition, the sensor wires 113 connected to the sensors or the network connection line 116 connected with the network 106 can be introduced into the interior of the housing of the multifunction apparatus 600 through the opening portion 209.

As illustrated in FIG. 19B, the sensor input board 301 and the network board 401 are attached to the multifunction apparatus 600, in addition to the components of the base apparatus 200.

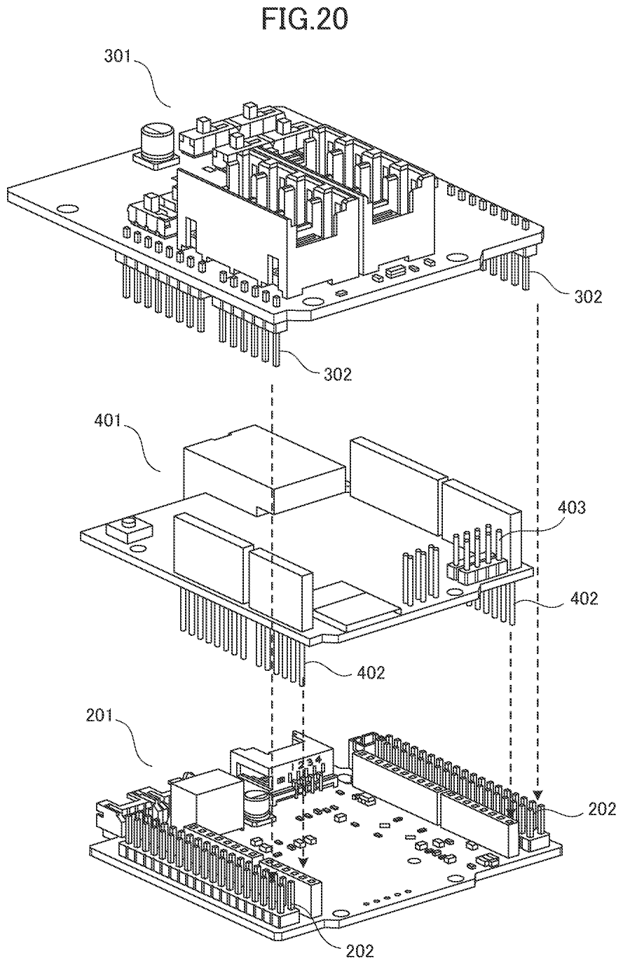

FIG. 20 is an enlarged view of an external appearance of the sensor input board 301, the network board 401, and the master circuit board 201. The sensor input board 301 is placed over the network board 401, and the sensor input board 301 and the network board 401 are mounted on the master circuit board 201. As described previously, terminals of the connector 202 for the sensor input board arid terminals of the connector 202 for the network board are disposed at different positions. Consequently, even if the sensor input board and the network board are both connected to the connector 202, mechanical and electrical interference does not occur. In addition, the I/O port 403 is disposed in an edge portion of the network board 401, so that the network connection line 116 can be connected to the network board 401 without interfering with the sensor input board 301.

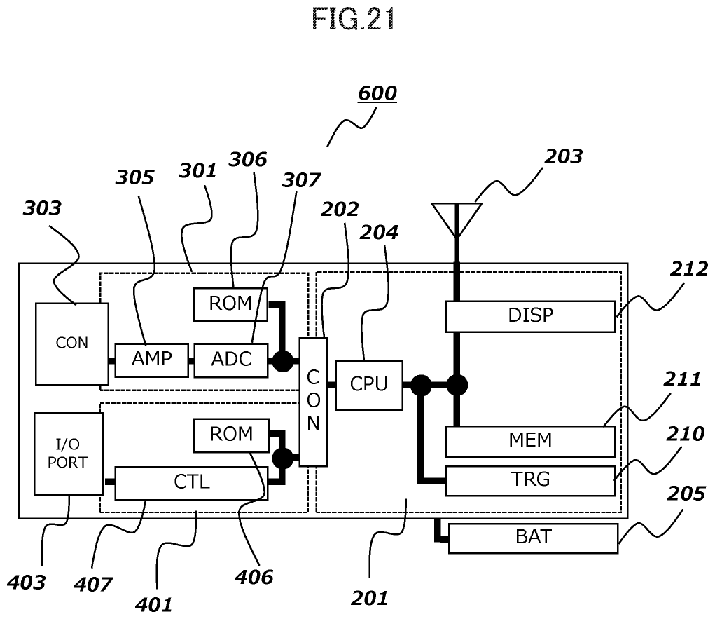

FIG. 21 is a block diagram for illustrating a circuit configuration of the multifunction apparatus 600. In the multifunction apparatus 600, the sensor input board 301 and the network board 401 are connected with the connector 202 of the master circuit board 201.

The sensor input board 301 includes a function that determines whether the sensor wires 113 are connected to the connector 303, in addition to the functions previously described for describing the node apparatus. In addition, the network board 401 includes a function that determines whether the network connection line 116 is connected to the I/O port 403, in addition to the functions previously described for describing the gateway apparatus.

After the power is turned on and the multifunction apparatus 600 is activated, the CPU 204 of the master circuit board 201 communicates with the sensor input board 301 and the network board 401, and continuously determines whether the sensor wires or the network connection line is connected to the multifunction apparatus 600. If the CPU 204 determines that the sensor wires or the network connection line is connected to the multifunction apparatus 600, the CPU 204 causes the multifunction apparatus 600 to operate as the node apparatus or the gateway apparatus, as described above.

The multifunction apparatus of the embodiment has been described above. Since the multifunction apparatus described above is merely one example, the configuration of the multifunction apparatus and the method of controlling the multifunction apparatus can be changed as appropriate.

The multifunction apparatus of the present embodiment can be easily produced by only attaching the sensor input board and the network board to the base apparatus. Thus, if an administrator or a user of the system prepares a plurality of base apparatuses having substantially an identical configuration, a plurality of sensor input boards, and a plurality of network boards, the administrator or the user can easily change the number of multifunction apparatuses installed in the system. In addition, the multifunction apparatus of the present embodiment becomes the gateway apparatus if the sensor input board is removed, and becomes the node apparatus if the network board is removed. Thus, the multifunction apparatus can be easily changed to a different apparatus. In addition, the multifunction apparatus of the present embodiment becomes the base apparatus again if the sensor input board and the network board are removed from the multifunction apparatus. Thus, the multifunction apparatus can be easily changed to the repeater apparatus. In addition, when the multifunction apparatus is kept in a storage space, the interior of the multifunction apparatus can be protected from moisture and dust, by closing the lid.

### Modifications

Note that the present invention is not limited to the above-described embodiments, and can be variously modified within the technical concept of the present invention.

For example, the control program of the base apparatus may operate such that if no board is connected to the connector 202, the base apparatus automatically executes the function of the repeater apparatus. In this case, if the sensor input board is connected to the connector 202, the repeater apparatus is changed to the node apparatus, and if the sensor input board is removed from the node apparatus, the node apparatus becomes the repeater apparatus again. Similarly, if the network board is connected to the connector 202, the repeater apparatus is changed to the gateway apparatus, and if the network board is removed from the gateway apparatus, the gateway apparatus becomes the repeater apparatus again. In addition, if both the sensor input board and the network board are connected to the connector 202, the repeater apparatus is changed to the multifunction apparatus. Thus, this configuration can easily build or change the network system without using the repeater board.

In addition, for easily managing a plurality of base apparatuses, each base apparatus may be provided with a corresponding ID to identify the base apparatus, and the ID may be stored in the memory 211 of the master circuit board 201. In this case, each base apparatus sends its ID and operation state to the computer 108 of the system, at an appropriate timing such as a time of power-on. That is, the base apparatus sends its ID and operation state to the computer 108 by using the communication unit 203 when the base apparatus is operating as the node apparatus or the repeater apparatus, or by using the I/O port 403 when the base apparatus is operating as the gateway apparatus.

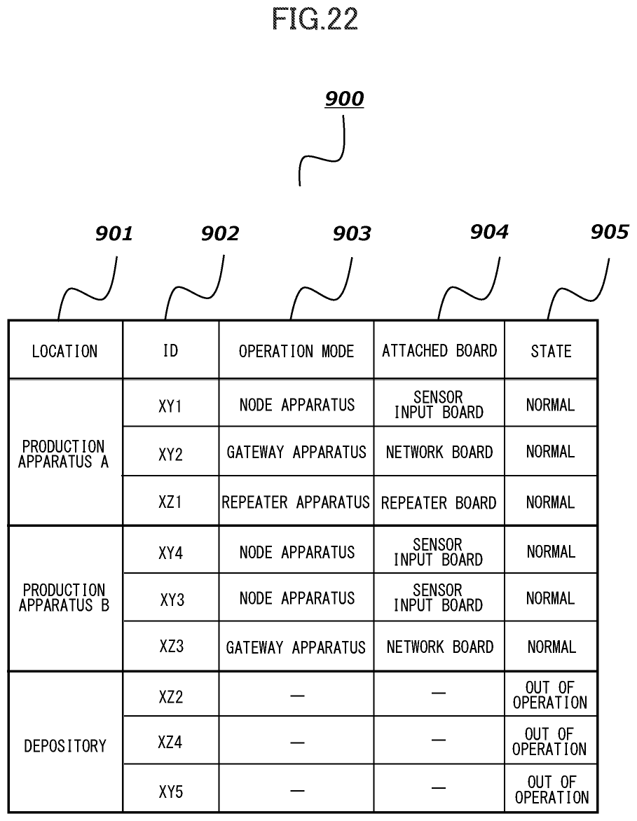

FIG. 22 illustrates one example of images displayed on the display screen of the computer 108 that controls the whole system. A displayed image 900 is a table used for managing a plurality of base apparatuses. A column 901 indicates the location of each base apparatus. In this example, three base apparatuses are installed in each of a production apparatus A and a production apparatus B, and three base apparatuses are kept in a depository. A column 902 indicates an ID of each base apparatus; a column 903 indicates an operation mode (that is, which apparatus the base apparatus is operating as) of each base apparatus; and a column 904 indicates the type of a board attached to each base apparatus. In addition, a column 905 indicates an operation state of each apparatus.

For example, a base apparatus (first base apparatus) which has an ID of XY1 and to which a sensor input board is attached is operating normally as a node apparatus, in a system that monitors the production apparatus A. In addition, a base apparatus (second base apparatus) which has an ID of XY2 and to which a network board is attached is operating normally as a gateway apparatus, in a system that monitors the production apparatus A. In addition, a base apparatus (third base apparatus) which has an ID of XZ2 and to which no board is attached is stored in the depository. Since FIG. 22 is one example of administration screens, the administration screen can be automatically generated, modified variously, for convenience of an administrator or a user of the system. For example, the column 901 may additionally indicate more detailed information. Specifically, the column 901 may indicate which position of an apparatus a base apparatus is installed in, or may indicate which position of a depository a base apparatus is placed in. In addition, the column 904 may additionally indicate more detailed information, such as the setting information of a board. In addition, the column 905 may additionally indicate more detailed information, such as remaining battery life. In addition, although not illustrated in FIG. 22, types and the number of boards kept in a depository may be displayed on a screen of the system.

Thus, an administrator or an operator of the system of the embodiment can easily check the operation state of each base apparatus by using the computer 108, and thus can easily manage the system.

The apparatus produced by attaching a board to the base apparatus is not limited to the node apparatus, the gateway apparatus, the repeater apparatus, and the multifunction apparatus that serves as the node apparatus and the gateway apparatus. An apparatus other than the apparatuses described as examples in the embodiment may be produced by attaching a board other than the boards described as examples in the embodiment, to the base apparatus.

A control program that can execute the method of controlling the above-described base apparatus, and a computer-readable recording medium that stores the control program are also included in the embodiments of the present invention.

The system of the embodiment can be embodied as a system that acquires the state of various facilities including a robot which is operated in a production line, and that monitors the facilities. For example, the robot is a piece of mechanical equipment that can automatically perform expansion and contraction, bending and stretching, up-and-down movement, right-and-left movement, pivot, or combined movement thereof, in accordance with information stored in the storage device of the control device.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-176776, filed Oct. 21, 2020, which is hereby incorporated by reference herein in its entirety.

What is claimed is:

1. An apparatus comprising a connector, wherein the apparatus is configured to
operate as a node apparatus if a first component is connected to the connector, and
operate as a gateway apparatus if a second component is connected to the connector.

2. The apparatus according to claim 1, wherein the apparatus is configured to operate as the node apparatus or the gateway apparatus if the first component and the second component are connected to the connector.

3. The apparatus according to claim 1, wherein the first component is a sensor board comprising:
a sensor input terminal configured to connect the apparatus with a sensor that measures a state of a facility; and
a storage portion configured to store information on setting that causes the apparatus to operate as the node apparatus.

4. The apparatus according to claim 1, wherein the second component is a network board comprising:
a network connection terminal configured to connect the apparatus to a network; and
a storage portion configured to store information on setting that causes the apparatus to operate as the gateway apparatus.

5. The apparatus according to claim 1, wherein the apparatus is configured to operate as a repeater apparatus if no component is connected to the connector.

6. The apparatus according to claim 1, wherein the apparatus is configured to operate as a repeater apparatus if a third component is connected to the connector.

7. The apparatus according to claim 6, wherein the third component is a repeater board comprising:
a storage portion configured to store information on setting that causes the apparatus to operate as the repeater apparatus.

8. The apparatus according to claim 1, Wherein the connector comprises a first connector to which the first component is connected, and a second connector to which the second component is connected, and
wherein the apparatus comprises a master circuit board on which the first connector and the second connector are disposed.

9. The apparatus according to claim 8, wherein the first connector is disposed outside the second connector in the master circuit board.

10. The apparatus according to claim 8, wherein the first connector is higher than the second connector in height.

11. A computer-readable non-transitory recording medium storing a control program that causes the apparatus according to claim 1 to operate as the node apparatus or the gateway apparatus.

12. A node apparatus comprising:
a master circuit board comprising a first connector configured to be connected with a network board, and a second connector; and
a sensor board detachably connected to the second connector.

13. The node apparatus according to claim 12, wherein the sensor board comprises:
a sensor input terminal configured to connect the node apparatus with a sensor that measures a state of a facility; and
a storage portion configured to store information on setting that causes an apparatus to operate as the node apparatus.

14. A gateway apparatus comprising:
a master circuit board comprising a first connector configured to be connected with a sensor board, and a second connector; and
a network board detachably connected to the second connector.

15. The gateway apparatus according to claim 14, wherein the network board comprises:
a network connection terminal configured to connect the gateway apparatus to a network in which a system is built; and
a storage portion configured to store information on setting that causes an apparatus to operate as the gateway apparatus.

16. A repeater apparatus comprising:
a master circuit board comprising a first connector configured to be connected with a network board, a second connector configured to be connected with a sensor board, and a third connector; and
a repeater board detachably connected to the third connector.

17. The repeater apparatus according to claim 16, wherein the repeater board comprises:
a storage portion configured to store information on setting that causes an apparatus to operate as the repeater apparatus.

18. A system comprising:
a node apparatus comprising
a first apparatus comprising a master circuit board comprising a connector, and a first component detachably connected to the connector of the first apparatus;
a gateway apparatus comprising a second apparatus, and a second component detachably connected to the connector of the second apparatus; and
a computer connected to a network.

19. The system according to claim 18, wherein the first component is a sensor board comprising:
a sensor input terminal configured to connect the first apparatus with a sensor that measures a state of a facility; and
a storage portion configured to store information on setting that causes the first apparatus to operate as the node apparatus.

20. The system according to claim 18, wherein the second component is a network board comprising:
a network connection terminal configured to connect the second apparatus to the network; and
a storage portion configured to store information on setting that causes the second apparatus to operate as the gateway apparatus.

21. The system according to claim 18, further comprising a third apparatus.

22. The system according to claim 21, wherein the third apparatus is configured to operate as a repeater apparatus if no component is connected to the connector of the third apparatus.

23. The system according to claim 21, wherein the third apparatus is configured to operate as a repeater apparatus if a third component is connected to the connector of the third apparatus.

24. The system according to claim 23, wherein the third component is a repeater board comprising:
a storage portion configured to store information on setting that causes the third apparatus to operate as the repeater apparatus.

25. The system according to claim 18, wherein the connector comprises a first connector to which the first component is connected, and a second connector to which the second component is connected, and
wherein the first connector is disposed outside the second connector in the master circuit board.

26. The system according to claim 25. wherein the first connector is higher than the second connector in height.

27. A method of controlling a system, wherein the computer of the system according to claim 18 displays information on a state of the first apparatus and a state of the second apparatus.

28. A production facility in which the system according to claim 18 is installed.

29. A method of manufacturing products while acquiring a state of a production facility by using the system according to claim 18.
